(19) United States
(12) Patent Application Publication
(10) Pub. No.: US 2023/0357569 A1
(43) Pub. Date: Nov. 9, 2023

(54) POLYAMIDE FILAMENTS FOR USE IN 3D PRINTING

(71) Applicant: BASF SE, Ludwigshafen am Rhein (DE)

(72) Inventors: Simone SCHILLO, Ludwigshafen am Rhein (DE); Claus GABRIEL, Ludwigshafen am Rhein (DE); Angelika ZEPP, Ludwigshafen am Rhein (DE); Christian LEMAIRE, Ludwigshafen am Rhein (DE); Moritz KOENIG, Ludwigshafen am Rhein (DE); Matthias FISCHER, Heidelberg (DE); Tim MOSTBERGER, Heidelberg (DE); Jessica GOERICH, Heidelberg (DE)

(21) Appl. No.: 18/022,761

(22) PCT Filed: Aug. 24, 2021
(86) PCT No.: PCT/EP2021/073431

§ 371 Date: Feb. 23, 2023

(30) Foreign Application Priority Data
Aug. 26, 2020 (EP) 20192881.9

(51) Int. Cl. B29B 7/88; B33Y 70/00; B29B 7/00; C08L 77/06; C08K 5/5313; C08K 3/22

(52) U.S. Cl. CPC C08L 77/06; B29B 7/007; B29B 7/88; B33Y 70/00; C08K 3/22; C08K 5/5313; B29C 2948/92019; B29C 2948/92209; B29L 2031/731; C08K 2003/2224; C08K 2201/003

(57) ABSTRACT

The present invention relates to a filament for 3D printing, comprising (A) at least one semicrystalline polyamide, (B) at least one amorphous polyamide (C) at least one flame retardant of formula (I), wherein R¹ and R² are independently of each other a linear or branched C₁-C₈alkyl group, or an optionally substituted aryl group, M represents is an alkali metal ion, an alkaline earth metal ion, an aluminum ion, a zinc ion, an iron ion or a boron ion; m represents 1, 2 or 3; and n represents 1, 2 or 3, a process for the preparation of the filament and its use in a process for preparation of a three-dimensional object, by a fused filament fabrication process.

The present invention relates to a filament for 3D printing, comprising (A) at least one semicrystalline polyamide, (B) at least one amorphous polyamide (C) at least one flame retardant of formula (I), a process for the preparation of the filament and its use in a process for preparation of a three-dimensional object, by a fused filament fabrication process.

Aluminum salts of phosphinic acids are valuable flameproofing agents for polyester and polyamide molding compositions (EP0699708A2 and EP923586B1).

EP1670862B1 relates to flameproofed polyamide molding compounds consisting of
a) 20 - 80% by weight of one or more aliphatic polyamides,
b) 1 - 40% by weight of one or more partially aromatic polyamides,
c) 1 - 18% by weight of a flameproofing agent consisting of a phosphinic acid salt of Formula (I) and/or a diphosphinic acid salt of Formula (II) and/or polymers thereof

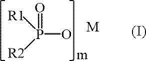

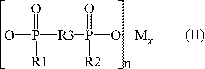

wherein
   R¹, R² are identical or different and represent C₁-C₆alkyl, linear or branched, and/or aryl,
   R³ represents C₁-C₁₀alkylene, linear or branched, C₆-C₁₀arylene, alkylarylene or arylalkylene;
   M represents a metal ion from the 2^{nd} or 3^{rd} main or subgroup of the periodic table;
   m represents 2 or 3;
   n represents 1 or 3;
   x represents 1 or 2,
d) 5 - 60% by weight of a fibrous or particulate filler or mixtures thereof,
e) 0.05 - 10% by weight additives, selected from stabilisers, processing aid, anti-dripping agent, colouring agents and/or pigments, the total of the components a) to e) making up 100% by weight.

EP2886605B1 relates to thermoplastic moulding compounds consisting of:
(A) 21-81.9 wt.% thermoplastic material, consisting of
   (A1) 55-100 wt.% polyamide, containing at least 50 wt.% partly aromatic, partly crystalline polyamide;
   (A2) 0-45 wt.% non-polyamide based thermoplastic material (A2_1), an impact modifier
      (A2_2) different therefrom, or mixtures thereof,
         wherein (A1) and (A2) add up to 100 wt.% component (A);
(B) 10-70 wt.% glass fibres;
(C) 0.1-10 wt.% LDS additive or a mixture of LDS additives;
(D) 8-18 wt.% halogen-free flame retardant;
(E) 0-40 wt.% particulate filler, different from (C);
(F) 0-2 wt.% other further additives; wherein the sum of (A)-(F) makes up 100 wt.%.

EP2902444B1 relates to polyamide moulding compound consisting of
a) 22 to 99.99% by weight of a polyamide mixture, consisting of
   (A1) at least one partially aromatic, partially crystalline polyamide with a melting point in the range of 255 to 330° C.,
   (A2) at least one caprolactam-containing polyamide which differs from the at least one partially aromatic, partially crystalline polyamide (A1) and has a content of caprolactam of at least 50% by weight,
      the total caprolactam content of the caprolactam contained in polyamide (A1) and polyamide (A2), relative to the polyamide mixture, being 3 to 35% by weight,
   b) 0 to 25% by weight of at least one flame retardant,
c) 0.01 to 3.0% by weight of at least one organic heat stabiliser and
d) 0 to 50% by weight of at least one additive, components a) to d) adding up to 100% by weight,
   characterised in that the polyamide moulding compound is free of metal salts and metal oxides of a transition metal of group VB, VIB, VIIB or VIIIB of the periodic table.

EP2438113B1 relates to polyamide molding compositions based on semicrystalline polyamides, consisting of
(A) at least 30% by weight of at least one aliphatic semicrystalline polyamide with melting point (Tm) in the range from 240° C. to 340° C. and/or a semiaromatic, semicrystalline polyamide with melting point (Tm) in the range from 240° C. to 340° C., wherein the melting point (Tm) in each case is determined according to ISO Norm 11357-11-2 in a granulate with differential scanning calorimetry (DSC) with a heating rate of 20° C./min;
(B) from 0 to 50% by weight of at least one filler and reinforcing agent;
(C) from 8 to 16% by weight of at least one halogen-free flame retardant;
(D) from 0.1 to 2.0% by weight of at least one barium carboxylate;
(E) from 0 to 5% by weight of at least one additive; wherein the percentages by weight of components (A) to (E) give a total of 100%.

US2014/0141168 (WO2014081594) describes a polyamide blend for use as filament in a 3D printing process. The polyamide blend comprises a semicrystalline polyamide such as nylon-6, nylon-66, nylon-6,9, nylon-7, nylon-11, nylon-12 and mixtures thereof, and, as amorphous polyamide, 30 to 70% by weight of nylon-6/3T, for example.

WO2018/019730 relates to a process for producing a shaped body by selective laser sintering of a sinter powder (SP). The sinter powder (SP) comprises at least one semicrystalline polyamide, at least one nylon-6I/6T and at least one polyaryl ether.

WO2018/019727 relates to a process for producing a shaped body by selective laser sintering of a sinter powder (SP). The sinter powder (SP) comprises at least one semicrystalline polyamide and at least one nylon-6I/6T. The present invention further relates to a shaped body obtainable by the process of the invention and to the use of nylon-6I/6T in a sinter powder (SP) for broadening the sintering window (WSP) of the sinter powder (SP).

US20190160737A1 (WO2018/019728) relates to process for producing a shaped body by selective laser sintering of a sinter powder (SP), wherein the sinter powder (SP) comprises the following components:
(A) at least one semicrystalline polyamide comprising at least one unit selected from the group consisting of —NH—(CH2)m—NH— units where m is 4, 5, 6, 7 or 8, —CO—(CH2)n—NH— units where n is 3, 4, 5, 6 or 7, and —CO—(CH2)o—CO— units where o is 2, 3, 4, 5 or 6,
(B) at least one nylon-6I/6T,
(C) at least one reinforcing agent, wherein
   component (C) is a fibrous reinforcing agent in which the ratio of length of the fibrous reinforcing agent to diameter of the fibrous reinforcing agent is in the range from 2:1 to 40:1.

WO201968658A1 relates to a process for producing a molded article comprising the steps of: i) providing a layer of a sintering powder (SP), the components
(A) at least one semi-crystalline polyamide,
(B) at least one amorphous polyamide,
(C) at least one near infrared reflector ii ) exposing said layer provided in step i) the sintering powder (SP).

WO2019/068659 relates to a process for producing a molded article, wherein in step i) a layer of a sintering powder (SP), which contains at least one mineral flame retardants, is provided, and the layer provided in step i) is exposed in step ii). Furthermore, the present invention relates to a method for producing a sintered powder (SP) and a sintering powder (SP) obtainable by this process.

WO2015/116922 relates to filaments comprising a polymer blend and specific articles comprising the filament are disclosed. The polymer blend includes an aliphatic nylon and a semiaromatic nylon. The aliphatic nylon is the major component of the blend and semiaromatic nylon is the minor component of the blend. The aliphatic nylon can be Nylon 6, Nylon 66, Nylon 610, Nylon 612, Nylon 12, and mixtures thereof. The semiaromatic nylon can be 6I/6T, 6T/6I, and mixtures thereof.

WO2019208741 relates to polyamide material which comprises a resin composition comprising crystalline polyamide resin and an amorphous polyamide resin, and the crystallization enthalpy of the resin composition as determined by differential scanning calorimetry is 5-60 J/g.

WO2019/208741A1 discloses polyamide-based 3D printer materials, comprising:

a resin composition (C), wherein the resin composition (C) contains a crystalline polyamide-based resin (A) and an amorphous polyamide-based resin (B), and a heat quantity of crystallization of the resin composition (C) in differential scanning calorimetry is from 5 to 60 J/g. The materials may contain flame retardants.

US2013/203910A1 relates to polyamide resin compositions comprising a polyamide resin, at least one flame retardant, and at least one reinforcing agent, wherein,
a) the polyamide resin comprises at least one aliphatic polyamide and an aromatic polyamide blend comprising at least one semi-crystalline semi-aromatic polyamide and at least one amorphous semi-aromatic polyamide;
b) based on the total weight of the polyamide resin, about 35 to about 70 wt % of the at least one aliphatic polyamide and about 30 to about 65 wt % of the aromatic polyamide blend are present in the polyamide resin; and
c) based on the total weight of the aromatic polyamide blend, about 15 to about 80 wt % of the at least one semi-crystalline semi-aromatic polyamide and about 20 to about 85 wt % of the at least one amorphous semi-aromatic polyamide are present in the aromatic polyamide blend; and molded articles comprising the polyamide resin compositions.

US2020/247995A1 discloses compositions for 3D printing based on an amorphous polyamide and a semi-crystalline polymer which could be polyamide. The amorphous polyamide is based on dimerized fatty acid.

US2020/048414A1 discloses filaments comprising a polymer composition, said polymer composition comprising:
A) 55 to 95 weight percent semi-aromatic copolyamide having a melting point; wherein said semi-aromatic copolyamide comprises
   a-1) 5 to 40 mole percent aromatic repeat units derived from:
      i) one or more aromatic dicarboxylic acids with 8 to 20 carbon atoms and an aliphatic diamine with 4 to 20 carbon atoms; and
   a-2) 60 to 95 mole percent aliphatic repeat units derived from:
      ii) an aliphatic dicarboxylic acid with 6 to 20 carbon atoms and an aliphatic diamine with 4 to 20 carbon atoms; and
B) 5 to 45 weight percent amorphous copolyamide having a melting point; wherein said amorphous copolyamide comprises
   b-1) 60 to 90 mole percent aromatic repeat units derived from:
      iii) isophthalic acid and an aliphatic diamine with 4 to 20 carbon atoms; and
   b-2) 10 to 40 mole percent aromatic repeat units derived from:
      iv) terephthalic acid and an aliphatic diamine with 4 to 20 carbon atoms.

It has been found that, surprisingly, three dimensional objects which have been produced using the filaments of the invention have a particularly good UL 94 flame retardancy level, an excellent adhesion on glass print beds and very low warpage without significant adverse effect on the other properties of the shaped bodies, such as, for example, mechanical properties, especially modulus and tensile strength, and elevated toughness relative to three dimensional objects that do not comprise any component (C).

It is thus an object of the present invention to provide a filament for 3D printing, comprising
(A) is selected from the group consisting of PA 4, PA 6, PA 7, PA 8, PA 9, PA 11, PA 12, PA 46, PA 66, PA 69, PA 6.10, PA 6.12, PA 6.13, PA 6/6.36, PA6T/6, PA 12.12, PA 13.13, PA 6T, PA MXD6, PA 6/66, PA 6/12 and copolyamides of these;
(B) at least one amorphous polyamide is selected from the group consisting of PA 6I/6T, PA 6I and PA 6/3T;
(C) at least one flame retardant of formula

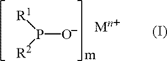

wherein
   R¹ and R² are independently of each other a linear or branched C₁-C₈alkyl group, or an optionally substituted aryl group,
   M represents is an alkali metal ion, an alkaline earth metal ion, an aluminum ion, a zinc ion, an iron ion or a boron ion;
   m represents 1, 2 or 3; and n represents 1, 2 or 3. The filament may further comprise at least one additive (D).

### Filament

According to the invention, filament comprises at least one semicrystalline polyamide as component (A), at least one amorphous polyamide as component (B), at least one flame retardant as component (C) and optionally at least one additive (D).

In the context of the present invention the terms “component (A)” and “at least one semicrystalline polyamide” are used synonymously and therefore have the same meaning.

The terms “in the range of from 10% to 25% by weight of component (B)” etc. means: 10% by weight ≤ amount of component (B) ≤ 25% by weight etc.

The same applies to the terms “component (B)” and “at least one amorphous polyamide”. These terms are likewise used synonymously in the context of the present invention and therefore have the same meaning.

Correspondingly, the terms “component (C)” and “at least one flame retardant” are also used synonymously in the context of the present invention and have the same meaning.

The filament may comprise components (A), (B) and (C) in any desired amounts. The filament may further comprise at least one additive (D).

For example, the filament comprises in the range of from 30% to 80% by weight of component (A), in the range of from 5% to 30% by weight of component (B), in the range of from 15% to 50% by weight of component (C) and in the range of from 0% to 10% by weight of component (D) based in each case on the total weight of the filament.

More preferably, the filament comprises in the range of from 45% to 75% by weight of component (A), in the range of from 10% to 25% by weight of component (B), in the range of from 20% to 40% by weight of component (C) and in the range of from 0% to 5% by weight of component (D) based in each case on the total weight of the filament.

Most preferably, the filament comprises in the range of from 50% to 70% by weight of component (A), in the range of from 10% to 25% by weight of component (B), in the range of from 20% to 35% by weight of component (C) and in the range of from 0% to 2.5% by weight of component (D) based in each case on the total weight of the filament.

The filament may further comprise at least one additive (D). For example, the at least one additive is selected from the group consisting of antinucleating agents, stabilizers, flow aids, end group functionalizers, dyes and color pigments.

An example of a suitable antinucleating agent is lithium chloride. Suitable stabilizers are, for example, phenols, phosphites and copper stabilizers.

Suitable end group functionalizers are, for example, terephthalic acid, adipic acid and propionic acid. Suitable dyes and color pigments are, for example, carbon black and iron chromium oxides.

For example, the filament comprises in the range of from 0.05% to 10% by weight of the at least one additive, preferably in the range of from 0.1% to 5% by weight and especially preferably in the range of from 0.1% to 2.5% by weight, based in each case on the total weight of the filament.

The percentages by weight of components (A), (B) and (C) and optionally of the at least one additive (D) typically add up to 100% by weight.

### Component (A)

Suitable components (A) have a viscosity number in the range of from 50 to 300 mL/g, preferably in the range of from 80 to 250 mL/g and especially preferably in the range of from 100 to 220 mL/g. The viscosity number is determined at 25° C. according to ISO 307:2019, in a 0.005 g/mL solution of component (A) in 96% by weight sulfuric acid.

Suitable as the at least one semicrystalline polyamide (A) are, for example, semicrystalline polyamides (A) that derive from lactams having 4 to 12 ring members. Also suitable are semicrystalline polyamides (A) that are obtained by reaction of dicarboxylic acids with diamines. Examples of at least one semicrystalline polyamide (A) that derives from lactam include polyamides that derive from polycaprolactam and/or polycaprylolactam.

If at least a semicrystalline polyamide (A) obtainable from dicarboxylic acids and diamines is used, dicarboxylic acids used may be alkanedicarboxylic acids having 6 to 12 carbon atoms. Aromatic dicarboxylic acids are also suitable.

Examples of dicarboxylic acids here include adipic acid, azelaic acid, sebacic acid and dodecanedicarboxylic acid.

Examples of suitable diamines include alkanediamines having 4 to 12 carbon atoms and aromatic or cyclic diamines, for example m-xylylenediamine, di(4-aminophenyl)methane, di(4-aminocyclohexyl)methane, 2,2-di(4-aminophenyl)propane or 2,2-di(4-aminocyclohexyl)propane.

Preferred components (A) are polycaprolactam (nylon-6) and nylon-6/66 copolyamide. Nylon-6/66 copolyamide preferably has a proportion of 5% to 95% by weight of caprolactam units, based on the total weight of the nylon-6/66 copolyamide.

Also suitable as at least one semicrystalline polyamide (P) are polyamides obtainable by copolymerization of two or more of the monomers mentioned above and below or mixtures of a plurality of polyamides in any desired mixing ratio. Particular preference is given to mixtures of nylon-6 with other polyamides, especially nylon-6/66 copolyamide.

The non-comprehensive list which follows comprises the aforementioned polyamides and further suitable semicrystalline polyamides (A), and the monomers present.

AB polymers:

| | |
|---|---|
| PA 4 | pyrrolidone |
| PA 6 | ε-caprolactam |
| PA 7 | enantholactam |
| PA 8 | caprylolactam |
| PA 9 | 9-aminopelargonic acid |
| PA 11 | 11-aminoundecanoic acid |
| PA 12 | laurolactam |

AA/BB polymers:

| | |
|---|---|
| PA 46 | tetramethylenediamine, adipic acid |
| PA 66 | hexamethylenediamine, adipic acid |
| PA 69 | hexamethylenediamine, azelaic acid |
| PA 610 | hexamethylenediamine, sebacic acid |
| PA 612 | hexamethylenediamine, decanedicarboxylic acid |
| PA 613 | hexamethylenediamine, undecanedicarboxylic acid |
| PA 1212 | dodecane-1,12-diamine, decanedicarboxylic acid |
| PA 1313 | tridecane-1,13-diamine, undecanedicarboxylic acid |
| PA 6T | hexamethylenediamine, terephthalic acid |
| PA MXD6 | m-xylylenediamine, adipic acid |
| PA 6/66 | (see PA 6 and PA 66) |
| PA 6/12 | (see PA 6 and PA 12) |
| PA 6/6,36 | ε-caprolactam, hexamethylenediamine, C₃₆ dimer acid |
| PA 6T/6 | (see PA 6T and PA 6) |

Preferably, component (A) is selected from the group consisting of PA 4, PA 6, PA 7, PA 8, PA 9, PA 11, PA 12, PA 46, PA 66, PA 69, PA 6.10, PA 6.12, PA 6.13, PA 6/6.36, PA 6T/6, PA 12.12, PA 13.13, PA 6T, PA MXD6, PA 6/66, PA 6/12 and copolyamides of these.

More preferably, component (A) is selected from the group consisting of PA 6, PA 66, PA 6.10, PA 6.12, PA 6.36, PA 6/66, PA 6/6I6T, PA 6/6I and PA 6/6T.

Most preferably, component (A) is selected from the group consisting of nylon-6 and nylon-6/66.

### Component (B)

Component (B) is at least one amorphous polyamide.

In the context of the present invention “at least one amorphous polyamide” means either exactly one amorphous polyamide or a mixture of two or more amorphous polyamides.

“Amorphous” in the context of the present invention means that the polyamide does not have any melting point in differential scanning calorimetry (DSC) measured according to ISO 11357.

“No melting point” means that the enthalpy of fusion of the amorphous polyamide ΔH2(_{B}) is less than 10 J/g, preferably less than 8 J/g and especially preferably less than 5 J/g, in each case measured by means of differential scanning calorimetry (DSC) according to ISO 11357-4: 2014.

The at least one amorphous polyamide (B) of the invention thus typically has an enthalpy of fusion ΔH2(_{B}) of less than 10 J/g, preferably of less than 8 J/g and especially preferably of less than 5 J/g, in each case measured by means of differential scanning calorimetry (DSC) according to ISO 11357-4:2014.

Suitable amorphous polyamides generally have a viscosity number (VN(_{B})) in the range of from 60 to 200 mL/g, preferably in the range of from 70 to 150 mL/g and especially preferably in the range of from 75 to 125 mL/g, determined in a 0.5% by weight solution of component (B) in 96% by weight sulfuric acid at 25° C. to ISO 307:2019.

Component (B) of the invention typically has a glass transition temperature (T_{G}(_{B})), where the glass transition temperature (T_{G}(_{B})) is typically in the range of from 100 to 180° C., preferably in the range of from 110 to 160° C. and especially preferably in the range of from 120 to 145° C., determined by means of ISO 11357-2:2014.

Suitable components (B) have a weight-average molecular weight (M_{W}(_{B})) in the range of from 5000 to 35 000 g/mol, preferably in the range of from 10 000 to 30 000 g/mol and especially preferably in the range of from 15 000 to 25 000 g/mol. The weight-average molecular weight is determined by means of SEC-MALLS (Size Exclusion Chromatography Multi-Angle Laser Light Scattering) according to Chi-San Wu, “Handbook of Size Exclusion Chromatography and the Related Techniques”, page 19.

Component (B) is an amorphous semiaromatic polyamide. Amorphous semiaromatic polyamides of this kind are known to those skilled in the art and are selected, for example, from the group consisting of PA 6I/6T, PA 6I and PA 6/3T.

Component (B) is therefore preferably selected from the group consisting of PA6I/6T, PA 6I, PA 6/3T.

When polyamide 6I/6T is used as component (B), this may comprise any desired proportions of 6I and 6T structural units. Preferably, the molar ratio of 6I structural units to 6T structural units is in the range of from 1:1 to 3:1, more preferably in the range of from 1.5:1 to 2.5:1 and especially preferably in the range of from 1.8:1 to 2.3:1.

The MVR (275° C. / 5 kg) (melt volume flow rate) of component (B) is preferably in the range of from 50 mL/10 min to 150 mL/10 min, more preferably in the range of from 95 mL/10 min to 105 mL/10 min.

The zero shear rate viscosity η₀ of component (B) is, for example, in the range of from 770 to 3250 Pas. Zero shear rate viscosity η₀ is determined with a “DHR-1” rotary viscometer from TA Instruments and a plate-plate geometry with a diameter of 25 mm and a plate separation of 1 mm. Unequilibrated samples of component (B) are dried at 80° C. under reduced pressure for 7 days and these are then analyzed with a time-dependent frequency sweep (sequence test) with an angular frequency range of 500 to 0.5 rad/s. The following further analysis parameters were used: deformation: 1.0%, analysis temperature: 240° C., analysis time: 20 min, preheating time after sample preparation: 1.5 min.

Component (B) has an amino end group concentration (AEG) which is preferably in the range of from 30 to 45 mmol/kg and especially preferably in the range of from 35 to 42 mmol/kg.

For determination of the amino end group concentration (AEG), 1 g of component (B) is dissolved in 30 mL of a phenol/methanol mixture (volume ratio of phenol:methanol 75:25) and then subjected to potentiometric titration with 0.2 N hydrochloric acid in water.

Component (B) has a carboxyl end group concentration (CEG) which is preferably in the range of from 60 to 155 mmol/kg and especially preferably in the range of from 80 to 135 mmol/kg.

For determination of the carboxyl end group concentration (CEG), 1 g of component (B) is dissolved in 30 mL of benzyl alcohol. This is followed by visual titration at 120° C. with 0.05 N potassium hydroxide solution in water.

### Component (C)

According to the invention, component (C) is at least one flame retardant of formula

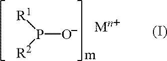

m represents 1, 2 or 3. and n represents 1, 2 or 3.

R¹ and R² are independently of each other a linear or branched C₁-C₈alkyl group, or an optionally substituted aryl group, especially a linear or branched C₁-C₆alkyl group, very especially an ethyl group.

M represents is an alkali metal ion, an alkaline earth metal ion, an aluminum ion, a zinc ion, an iron ion or a boron ion; especially an aluminum ion, or a zinc ion, very especially an aluminum ion.

Compounds of formula (I) are preferred, wherein M is AI, R¹ and R² represent a linear or branched C₁-C₆alkyl group, n is 3 and m is 3.

Compounds of formula (I) are more preferred, wherein M is AI, R¹ and R² is an ethyl group, n is 3 and m is 3.

Preferably, component (C) has
a D10 in the range of from 0.70 to 1.0 µm,
a D50 in the range of from 2.0 to 2.4 µm and
a D90 in the range of from 5.0 to 6.0 µm.

In the context of the present invention, the “D10” is understood to mean the particle size at which 10% by volume of the particles based on the total volume of the particles are smaller than or equal to D10 and 90% by volume of the particles based on the total volume of the particles are larger than D10. By analogy, the “D50” is understood to mean the particle size at which 50% by volume of the particles based on the total volume of the particles are smaller than or equal to D50 and 50% by volume of the particles based on the total volume of the particles are larger than D50. Correspondingly, the “D90” is understood to mean the particle size at which 90% by volume of the particles based on the total volume of the particles are smaller than or equal to D90 and 10% by volume of the particles based on the total volume of the particles are larger than D90.

To determine the particle sizes, the component (C) is suspended in a solvent, for example acetone, and this suspension is analysed. The D10, D50 and D90 values are determined by laser diffraction using a Malvern Mastersizer 2000.

The filaments of the present invention can be prepared by a process, comprising the steps of
a) mixing the following components:
   (A) at least one semicrystalline polyamide,
   (B) at least one amorphous polyamide,
   (C) at least one flame retardant,
   (D) optionally at least one additive and
b) filamenting the mixture obtained in step a) to obtain the filaments.

For compound production (step a) a co-rotating twin-screw extruder from Coperion (ZSK MC 26,) equipped with mixing screw (40D length) may be used.

Components (A), (B) and (D) are cold fed in zone 1, flame retardant (C) is hot fed in zone 5. To remove volatile ingredients from the melt, a vacuum degassing port may be installed in zone 7, operating at 300 mbar.

The production may be done at a throughput of 20 kg/h and a screw speed of 300 rpm. The processing temperature is depending on the product in the range of 240 - 300° C.

A Collin Lab line single-screw extruder E20T equipped with a Polyamide screw (25D) may be used to produce the filaments. At the end of the extruder, a die gear pump may be used for pressure regulation with a Ø 3.2 mm monofilament extrusion die.

During production the extruder pressure is set at 60 bar controlled automatically. The die pump speed is set on 31 rpm for 1.75 mm nominal diameter filament. The filament is cooled in a tempered water bath (~60° C.), followed by a cold-water bath (~20° C.).

A haul-off unit pulls the filament with a speed of 25 m/min, followed by the winder. Diameter and ovality of the produced filaments may be checked using a Zumbach measurement device. The filament is wound onto a standard size spool for 750 grams of filament (53 mm width; inner/outer diameter 104/200 mm).

Another subject of the invention is a consumable assembly for use in an extrusion-based additive manufacturing system, the consumable assembly comprising:

a container portion; and a filament according to claims 1 to 10 at least partially retained by the container portion.

Another subject of the invention is a process for preparation of a three-dimensional object, by a fused filament fabrication process, comprising at least the steps a), b), c), a) providing the filament according to any one of claims 1 to 10 on a spool to a nozzle, b) heating the filament to a temperature (TM),

c) depositing of the heated filament obtained in step b) in a build plate using a layer based additive technique in order to form the three-dimensional object.

According to step a), the filament according to the present invention, is provided on a spool to a nozzle.

According to step b), the filament is heated to a temperature (TM). The temperature (TM) is above the melting point of the semicrystalline polyamide. Methods for the determination of the melting point of the semicrystalline polyamide are known to the skilled person. For example, the melting point of the semicrystalline polyamide can be estimated by differential scanning calorimetry (DSC). In a preferred embodiment according to the present invention, in process step b) the filament is heated to a temperature (TM) that is at least 10° C., preferably at least 20° C. and particularly preferably at least 40° C. above the melting point of the semicrystalline polyamide.

In another preferred embodiment the filament is heated to a temperature (TM) in the range of from 180 to 400° C., preferably of from 210 to 310° C.

According to step c), the filament is deposited into a build plate using the layer-based additive technique. The temperature of the build plate is usually in the range of from 30 to 150° C., preferably of from 40 to 120° C. and particularly preferably of from 60 to 110° C.

In other words, in step a) to c) of the inventive process, the filament generally is initially present in a solid state and thereafter melted and printed to form a three-dimensional object comprising the filament.

A further subject of the invention is also the three-dimensional object prepared by the processes as specified above.

The following examples further illustrate the invention.

### EXAMPLES

The following components were used for the examples:

Semicrystalline polyamide (component (A)):

| | |
|---|---|
| (P1) nylon-6/66 | Ultramid® C33, BASF SE |
| (P2) nylon-6/66 | Ultramid® C27, BASF SE |
| (P3) nylon-6 | Ultramid® B27, BASF SE |

Amorphous polyamide (component (8)):

| | |
|---|---|
| (AP1) PA 6I/6T | Grivory G16, EMS-Chemie AG |

Flame retardant (component (C)):

| | |
|---|---|
| (FR1) Exolit® OP 935 | Exolit OP 935, organic phosphinate, Clariant Plastics & Coatings (Deutschland) GmbH; CAS No. 225789-38-8 |
| (FR2) Exolit® OP 950 | Exolit OP 950, organic phosphinate, Clariant Plastics & Coatings (Deutschland) GmbH; CAS No. 284685-45-6 |
| (FR3) Magnifin® H5IV | Magnifin H5 IV, Magnesium hydroxide, Albemarle, CAS No. 1309-42-8 |

Additive:

| | |
|---|---|
| (A1) Spezialschwarz 4 | Spezialschwarz 4, carbon black, Orion Engineered Carbons GmbH, CAS No. 1333-86-4 |
| (A2) Irganox® 1098 | Irganox® 1098, N,N′-hexane-1,6-diylbis(3-(3,5-di-tert-butyl-4-hydroxyphenylpropionamide)), BASF SE, CAS No. 23128-74-7 |

### Filament Production

### A) Compound Production:

To produce flame retardant Polyamide compounds, a co-rotating twin-screw extruder from Coperion (ZSK MC 26,) equipped with mixing screw (40D length) was used. Semi crystalline and amorphous polyamide, additives and colorants were cold fed in zone 1, flame retardant additives were hot fed in zone 5. To remove volatile ingredients from the melt, a vacuum degassing port was installed in zone 7, operating at 300 mbar. The trials were run at a throughput of 20 kg/h and a screw speed of 300 rpm. The processing temperature was depending on the product in the range of 240 - 300° C.

### B) Filament Production:

The filaments in the examples were prepared by extrusion of the compound applying the following materials, equipment and processing parameters.

To produce the filaments, a Collin Lab line single-screw extruder E20T equipped with a Polyamide screw (25D) was used. At the end of the extruder, a die gear pump is used for pressure regulation with a Ø 3.2 mm monofilament extrusion die.

During production, the extruder pressure was set at 60 bar controlled automatically. The die pump speed was set on 31 rpm for 1.75 mm nominal diameter filament. The filament was cooled in a tempered water bath (~60° C.), followed by a cold-water bath (~20° C.). A haul-off unit pulled the filament with a speed of 25 m/min, followed by the winder. Diameter and ovality of the produced filaments were checked using a Zumbach measurement device. The filament was wound onto a standard size spool for 750 grams of filament (53 mm width; inner/outer diameter 104/200 mm).

The composition of the filaments of Examples 1 to 5 and Comparative Examples V1 to V5 are shown in Table 1.

TABLE 1

| Ex. | P1 [wt. %] | P2 [wt. %] | P3 [wt. %] | AP1 [wt. %] | FR1 [wt. %] | FR2 [wt. %] | FR3 [wt. %] | A1 [wt. %] | A2 [wt. %] |
|---|---|---|---|---|---|---|---|---|---|
| 1 | 61.4 | | | 15.7 | 22.5 | | | | 0.4 |
| 2 | 59.3 | | | 15.7 | 25.0 | | | | |
| 3 | 54.1 | | | 15.7 | 30.0 | | | 0.2 | |
| 4 | | | 54.1 | 15.7 | 30.0 | | | 0.2 | |
| 5 | | 64.1 | | 10.5 | | 25.0 | | | 0.4 |
| V1 | | | 77.3 | | 22.5 | | | 0.2 | |
| V2 | 77.5 | | | | 22.5 | | | | |
| V3 | 79.6 | | | 20.0 | | | | | 0.4 |
| V4 | | | 78.4 | 21.0 | | | | 0.2 | 0.4 |
| V5 | | | 56.2 | 15.1 | | | 28.0 | 0.3 | 0.4 |

### Fused Filament Fabrication (FFF)

To produce UL94 test specimen and peel force test cylinders with a diameter of 3 cm and a height of 4.50 cm, the filament wounded onto a spool is pushed through the hot end of an extruder. The molten material exits a Ø 0.6 mm nozzle and form the three-dimensional objects.

### Peel Force Test

The measurement of the peel force requires a force gauge, suitable grips to clamp the specimens firmly, and a motor driven mechanism to pull the test specimen at a steady rate and controlled angle. For the test a TA.XT. plus from Texture Analyzer was used: Tests were performed at 180° peel angle and a speed of 0.1 mm/s. The force versus displacement curve was recorded with the software Exponent XT. plus.

The UL 94 classification, the warpage and adhesion rating of the three-dimensional objects obtained from the filaments of Examples 1 to 5 and Comparative Examples V1 to V5 are shown in Table 2.

TABLE 2

| Filaments of Example | UL 94 Class @ 0.8 mm Thickness | UL 94 Class @ 1.6 mm Thickness | Warpage Rating | Adhesion Rating | Max. Peel Force [N] |
|---|---|---|---|---|---|
| 1 | V-2 | V-0 | 1 | 1 | 539 |
| 2 | V-2 | V-0 | 1 | 1 | 654 |
| 3 | V-0 | V-0 | 1 | 1 | 704 |
| 4 | V-0 | V-0 | 2 | 2 | 343 |
| 5 | n.d. | V-2 | 2 | 1 | 547 |
| V1 | V-2 | V-0 | 5 | 5 | 1 |
| V2 | V-2 | V-0 | 2 | 2 | 328 |
| V3 | n.d. | n.d. | 1 | 4 | 58 |
| V4 | n.d. | n.d. | 4 | 5 | 25 |
| V5 | n.d. | V-2 | 3 | 5 | 27 |

The rating of warpage and adhesion on print bed is summarized in Table 3.

TABLE 3

| Rating | Warpage of test specimen | Adhesion of test specimen on print bed |
|---|---|---|
| 1 | very low | very good |
| 2 | slight | good |
| 3 | moderate | moderate |
| 4 | marked | adequate |
| 5 | severe | inadequate |

The filaments of the present invention show particularly good UL 94 flame retardancy level, an excellent adhesion on glass print beds and very low warpage as compared to the filaments of the Comparative Examples.

The addition of flame-retardant additives increases the adhesion of 3D printed test objects on glass print beds. The higher the loading of a certain flame-retardant additive in a polyamide resin, the higher was the obtained maximum peel strength. Lower peel strength in the Comparative Examples indicates a reduced adhesion between the 3D printed test objects and the glass print bed.

1-15. (canceled)

16. A filament for 3D printing, comprising
(A) at least one semicrystalline polyamide which is selected from the group consisting of PA 4, PA 6, PA 7, PA 8, PA 9, PA 11, PA 12, PA 46, PA 66, PA 69, PA 6.10, PA 6.12, PA 6.13, PA 6/6.36, PA6T/6, PA 12.12, PA 13.13, PA 6T, PA MXD6, PA 6/66, PA 6/12 and copolyamides thereof;
(B) at least one amorphous polyamide which is selected from the group consisting of PA 6I/6T, PA 6I and PA 6/3T;
(C) at least one flame retardant of formula 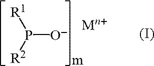
wherein
R¹ and R² are independently of each other a linear or branched C₁-C₈alkyl group, or an optionally substituted aryl group,
M represents is an alkali metal ion, an alkaline earth metal ion, an aluminum ion, a zinc ion, an iron ion or a boron ion;
m represents 1, 2 or 3; and n represents 1, 2 or 3; and
(D) optionally at least one additive.

17. The filament according to claim 16, wherein the filament comprises in the range of from 30% to 80% by weight of component (A), in the range of from 5% to 30% by weight of component (B) and in the range of from 15% to 50% by weight of component (C), and in the range of from 0 % to 10 % by weight of component (D) based in each case on the total weight of the filament.

18. The filament to claim 16, wherein component (A) is selected from the group consisting of PA 6, PA 66, PA 6.10, PA 6.12, PA 6.36, PA 6/66, PA 6/6I6T, PA 6/61 and PA 6/6T.

19. The filament according to claim 18, wherein component (A) is selected from the group consisting of PA 6 and PA 6/66.

20. The filament according to claim 16, wherein component (B) is selected from the group consisting of PA 6I/6T.

21. The filament according to claim 16, wherein M is Al, R¹ and R² represent a linear or branched C₁-C₆alkyl group, n is 3 and m is 3.

22. The filament according to claim 21, wherein R¹ and R² is an ethyl group.

23. The filament according to claim 16, wherein component (C) has a D10 in the range of from 0.70 to 1.0 µm, a D50 in the range of from 2.0 to 2.4 µm and a D90 in the range of from 5.0 to 6.0 µm.

24. The filament according to claim 16, wherein the diameter of the filament is 1.25 to 3.50 mm.

25. The filament according to claim 16, wherein the filament additionally comprises in the range of from 0.1% to 10% by weight of at least one additive selected from the group consisting of antinucleating agents, stabilizers, end group functionalizers, dyes and color pigments, based on the total weight of the filament.

26. A consumable assembly for use in an extrusion-based additive manufacturing system,
the consumable assembly comprising:
a container portion; and a filament according to claim 16 at least partially retained by the container portion.

27. A process for the preparation of a filament according to claim 16, comprising the steps of
a) mixing the following components:
(A) at least one semicrystalline polyamide,
(B) at least one amorphous polyamide,
(C) at least one flame retardant, and
(D) optionally the at least one additive; and
b) filamenting the mixture obtained in step a) to obtain a filament.

28. A process for preparation of a three-dimensional object, by a fused filament fabrication process, comprising at least the steps a), b), c),
a) providing the filament according to claim 16 on a spool to a nozzle,
b) heating the filament to a temperature (TM),
c) depositing of the heated filament obtained in step b) in a build plate using a layer based additive technique in order to form the three-dimensional object.

29. The process according to claim 28, wherein the temperature (TM) in step b) is 210 to 310° C.

30. A three-dimensional object, prepared by the process according to claim 28.
